(19) United States
(12) Patent Application Publication
(10) Pub. No.: US 2013/0112909 A1
(43) Pub. Date: May 9, 2013

(54) HIGHLY EFFICIENT THERMOELECTRIC MATERIAL

(71) Applicants: Chien-Neng Liao, Hsinchu City (TW); Hung-Hsien Huang, Hsinchu City (TW); Li-Chieh Wu, Hsinchu City (TW); Sin-Shien Lin, Hsinchu City (TW); Meng-Pei Lu, Hsinchu City (TW); Chien-Hao Chiu, Hsinchu City (TW)

(72) Inventors: Chien-Neng Liao, Hsinchu City (TW); Hung-Hsien Huang, Hsinchu City (TW); Li-Chieh Wu, Hsinchu City (TW); Sin-Shien Lin, Hsinchu City (TW); Meng-Pei Lu, Hsinchu City (TW); Chien-Hao Chiu, Hsinchu City (TW)

(73) Assignee: NATIONAL TSING HUA UNIVERSITY

(21) Appl. No.: 13/534,243

(22) Filed: Jun. 27, 2012

(30) Foreign Application Priority Data
Nov. 4, 2011 (TW) 100140273

(51) Int. Cl. C09K 3/00

(52) U.S. Cl. 252/62.3 T

(57) ABSTRACT

A highly efficient thermoelectric material with one end coated in silver adhesive and placed in a high temperature furnace to heat and diffuse the silver adhesive into the homogeneous thermoelectric material, thereby producing an non-uniform thermoelectric material one-side doped thermoelectric material. The non-uniform thermoelectric material one-side doped thermoelectric material is able to achieve a high thermoelectric figure of merit.

### BACKGROUND OF THE INVENTION

1. Field of the Invention

This invention relates to a highly efficient thermoelectric material, more specifically a kind of homogeneous thermoelectric material having one end coated in silver adhesive, and through heating produces an one-side doped thermoelectric material, this doped non-uniform thermoelectric material homogeneous thermoelectric material being highly efficient and possessing a high thermoelectric figure of merit.

2. Description of Related Art

Conventional homogeneous thermoelectric materials mainly convert thermal energy to electrical energy and vice versa, with most applications being for refrigeration and generating electricity. However, insufficient efficiency of thermoelectric conversion has long been a bottleneck of thermoelectric technology. Figure of merit defined as (ZT=α²T/κ ρ) is an important factor affecting efficiency of thermoelectric conversion. The Seebeck coefficient, represented as α, is defined as the voltage generated under one degree of temperature difference between two ends of uniform thermoelectric material under open circuit conditions. The higher the figure of merit; the better the thermoelectric efficiency, however due to the inherited limitation of uniformity and conventional thermoelectric material, a high figure of merit is hard to achieve.

And a thermoelectric generator with high conversion efficiency has to maximize the ratio of electric flux to heat flux in a parallel direction of the element, which requires the element having large thermal resistance and low electrical resistance. But we cannot change one without affecting the other by adjusting the dimensions of thermoelectric elements.

Besides, thermoelectric elements made by conventional thermoelectric material, which generates electrical energy through temperature difference have encountered some problems at the solder joints. First, the electrical energy is output from the metal solder joints at the two ends of the thermoelectric material, so these solder joints are located respectively at the lowest and the highest temperature ends of the conventional thermoelectric element. The highest temperature at the heated end is restricted to the low melting temperature of the metal soldering material at the joints. Second, the temperature gradient of thermoelectric material causes stress on the thermoelectric element due to non-uniform thermal expansion of the material, which may cause a fracture at the weakest point: the solder joints. The easily damaged solder joints result in poor reliability, and limit the usage of the elements under high temperature difference, so that the efficiency of thermoelectric conversion cannot be optimized.

Therefore, the inventor wishes to improve conventional thermoelectric material by improving higher figure of merit of thermoelectric material and modifying the temperature limitation of the solder joints, which restricts the efficiency of conventional thermoelectric elements. The problems needing to be solved involve the restriction of melting temperature at the hot end and the stress from non-uniform thermal expansion resulting in damage.

### SUMMARY OF THE INVENTION

The purpose of this invention is to produce highly efficient thermoelectric material by coating silver adhesive in a homogeneous thermoelectric material, and then heating the thermoelectric material with silver adhesive in a high temperature furnace to produce a one side silver doped thermoelectric material, so that a high figure of merit can be achieved.

The other goal of this invention is to achieve high thermoelectric efficiency by using non-uniform thermoelectric material to guide the electrical energy out from both the low temperature ends, instead of the hot and cold ends respectively, thus solving the problem of dimensions restrict of thermoelectric elements, the melting temperature of the soldering material at the hot end, and the damage result in thermal expansion.

The technical means to achieve the goals are: a homogeneous thermoelectric material; silver adhesive spread on one end of the homogeneous thermoelectric material; the homogeneous thermoelectric material with silver adhesive proceeds with a heating and diffusion process in a high temperature furnace to produce a one side silver doped thermoelectric material.

### BRIEF DESCRIPTION OF THE DRAWINGS

The invention, as well as its many advantages, may be further understood by the following detailed description and drawings in which:

FIG. 1a is the schematic diagram showing the homogeneous thermoelectric material with silver adhesive on the right side (This sample has not been heated and doped yet)

FIG. 1b is the schematic diagram showing a one-side doped thermoelectric material produced by thermal diffusion, and it shows two distinctly doped and un-doped regions of the first embodiment of the present invention.

FIG. 2 is a diagram showing the atomic percentage of dopant versus distance, after heating the thermoelectric material coated with silver adhesive of the first embodiment of the present invention.

FIG. 3 is a schematic diagram showing the highly efficient thermoelectric material proceeding with heating and measuring of the first embodiment of the present invention.

FIG. 4 is the measured data diagram showing voltages versus distance when applying a temperature gradient on the doped thermoelectric material of the first embodiment of the present invention.

FIGS. 5a and 5b are the schematic diagrams showing the second embodiment of the highly efficient thermoelectric material of the present invention.

### DETAILED DESCRIPTION OF THE INVENTION

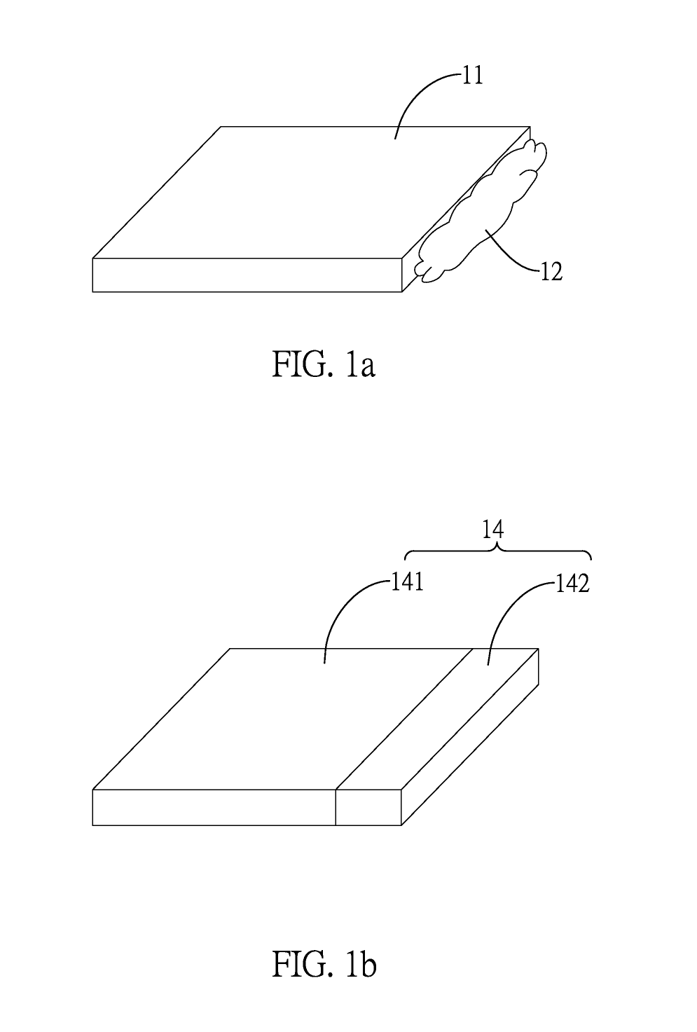

Please refer to both FIGS. 1a and 1b. The highly efficient thermoelectric material provided by the present invention is first selected from a homogenous thermoelectric material 11 (as shown in FIG. 1a), and coated with the silver adhesive 12 which is produced by a silver element, on one end of the homogenous thermoelectric material 11. After the procedure of heating the homogenous thermoelectric material 11 with the silver adhesive 12 in a high temperature furnace (not shown in the figure), the silver atoms of silver adhesive 12 are diffused into the homogeneous thermoelectric material 11. This diffusion process is by heating the homogeneous thermoelectric material 11 coated with the silver adhesive 12 for a period of two hours at 250˜350° C., so one single end of the one-side doped thermoelectric material 14 is doped with highly silver atoms (as shown in FIG. 1b) after going through the above procedures.

The two ends of the one-side doped thermoelectric material 14 are different in carrier concentration resulting from the non-uniform distribution of the dopant. One end has a highly doped region of silver atoms, which enhances its carrier concentration in the region (the high carrier concentration region), while the other end has the un-doped region (the low carrier concentration region), and its carrier concentration is unchanged (the two regions are separated by a solid line for clear description in the figure). The two doped and un-doped regions will have a distinct difference between their carrier concentrations.

The one-side doped thermoelectric material 14 is placed on a measuring device 15 to measure its performance. The heater 13 of the measuring device 15 is used to heat the doped end of the the one-side doped thermoelectric material 14, so that the temperature gradient is applied on one side of the one side doped thermoelectric material 14.

When the temperature difference is applied on the two ends of the one-side doped thermoelectric material 14, a high electrical potential difference can be measured by the voltage measuring electrodes 151 and 152 of the measuring device 15, which are respectively placed on the doped and un-doped ends of the one-side doped thermoelectric material 14. Dividing the generated voltage by the temperature difference, a greatly increased Seebeck coefficient is calculated.

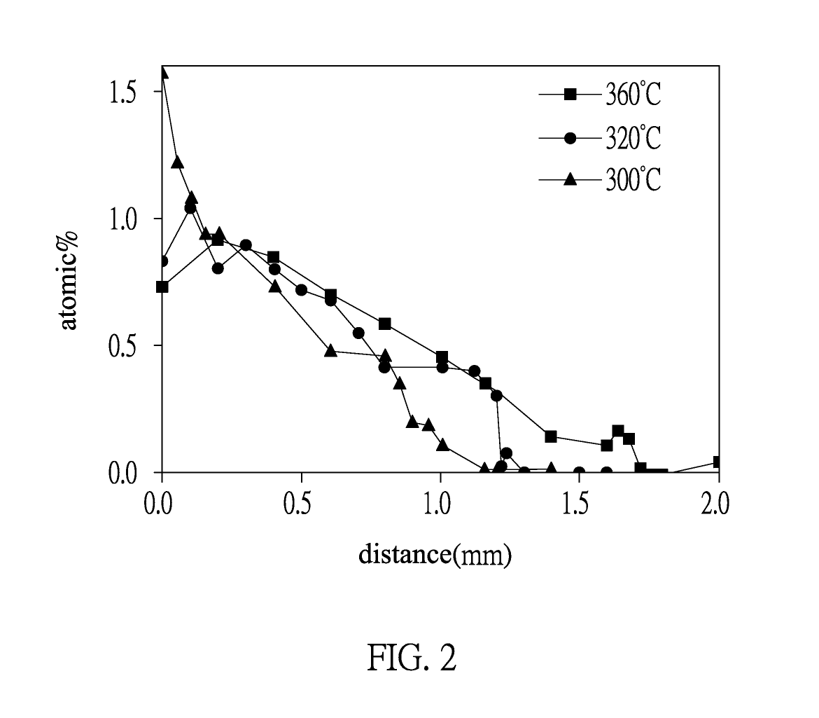

Please refer to FIG. 2, after heating the homogeneous thermoelectric material 11 of the first embodiment of the present invention, the homogeneous thermoelectric material 11 is coated with silver adhesive 12 in a high temperature furnace (not shown in the figure), and the silver atoms in the silver adhesive 12 are diffused into the homogeneous thermoelectric material 11 when at temperature above 300° C. From analyzing the composition it can be seen that the silver atomic percentage in the doped region decreases due to the typical concentration gradient phenomenon of thermal diffusion path from one end. (X-axis of the FIG. 2 is the distance between the analyzing point and the sample end).

A similar phenomenon can be observed after heating the homogenous thermoelectric material 11 up to 320° C. and 360° C. The silver atoms in the silver adhesive 12 can also be driven into the homogenous thermoelectric material 11, and the higher the heating temperature achieved; the deeper the dopants are diffused.

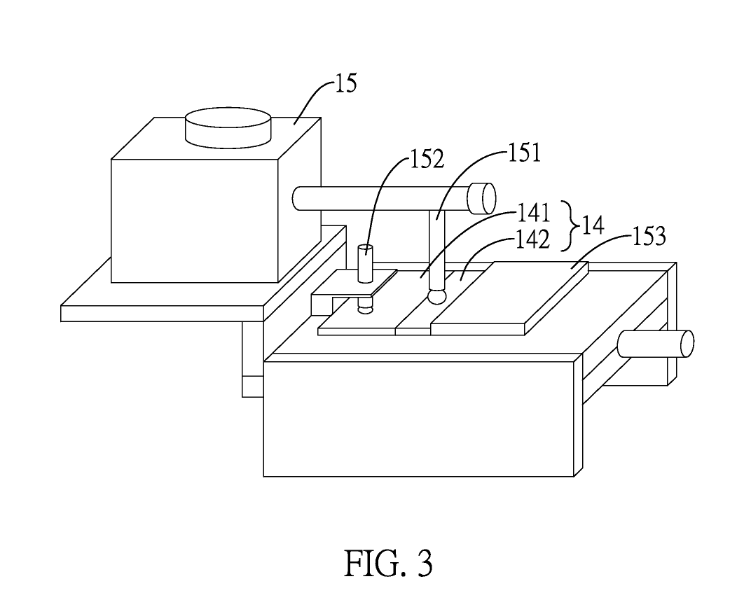

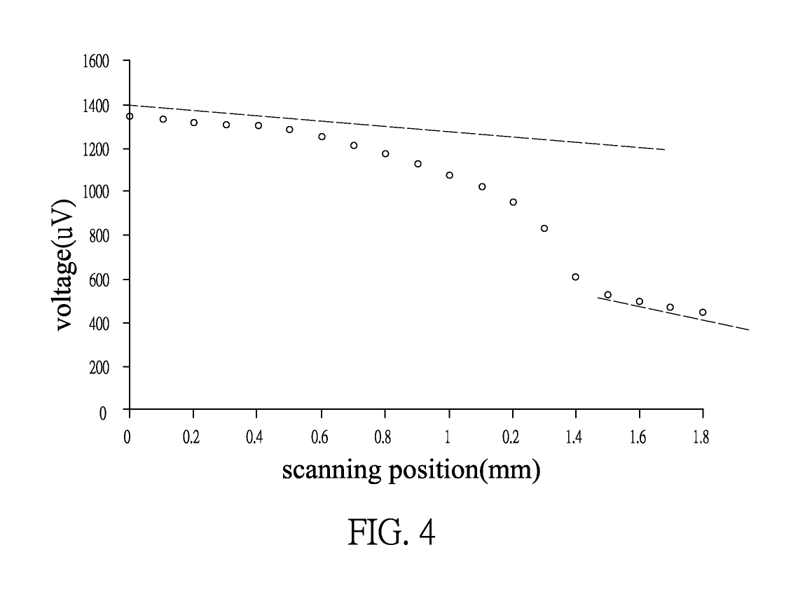

Please refer to FIG. 3 and FIG. 4, which show the first embodiment of the present invention using the heater 153 to heat the doped region 142 of the one side doped thermoelectric material 14. When the doped region 142 approaches the heater and a temperature gradient is applied on the sample, three different slope voltage profiles can be obtained by moving the electrode to different doping areas. The significant changes are illustrated as: A highest voltage (slope 1) obtained by the positive electrode 151 and the negative electrode 152 of the measuring device 15 that are respectively placed on the non-doped region 141 and the doped region 142 of the one-side doped thermoelectric material 14. And moving the positive electrode 151 from the doped region to the non-doped region, the sharp voltage drop occurred (slope 2) when the positive electrode 151 was moved to the area between the non-doped region and doped region. As the positive electrode 151 is moved to the non-doped region, in other words when both the positive 151 and negative electrodes 152 are placed in the non-doped region 141, the third measured voltage here is the lowest (slope 3).

If the direction of the one-side doped thermoelectric material 14 is reversed: the non-doped region 141 of the one-side doped thermoelectric material 14 approaches the heater 153 and is heated and the positive electrode 151 and the negative electrode 152 of the measuring device 15 are respectively placed on the non-doped region 141 and the doped region 142. The voltage obtained in this measurement setting is even lower than the third voltage.

In summary, when the doped region 142 is heated by the heater 153, the highest voltage sensed by electrodes 151 and 152 are placed on the doped (142) and non-doped region (141) respectively of the measuring device 15. And moving the electrode 151 from the doped region to non-doped region, the voltage sharply decreases, as both electrodes 151 and 152 are placed on the non-doped region 141.

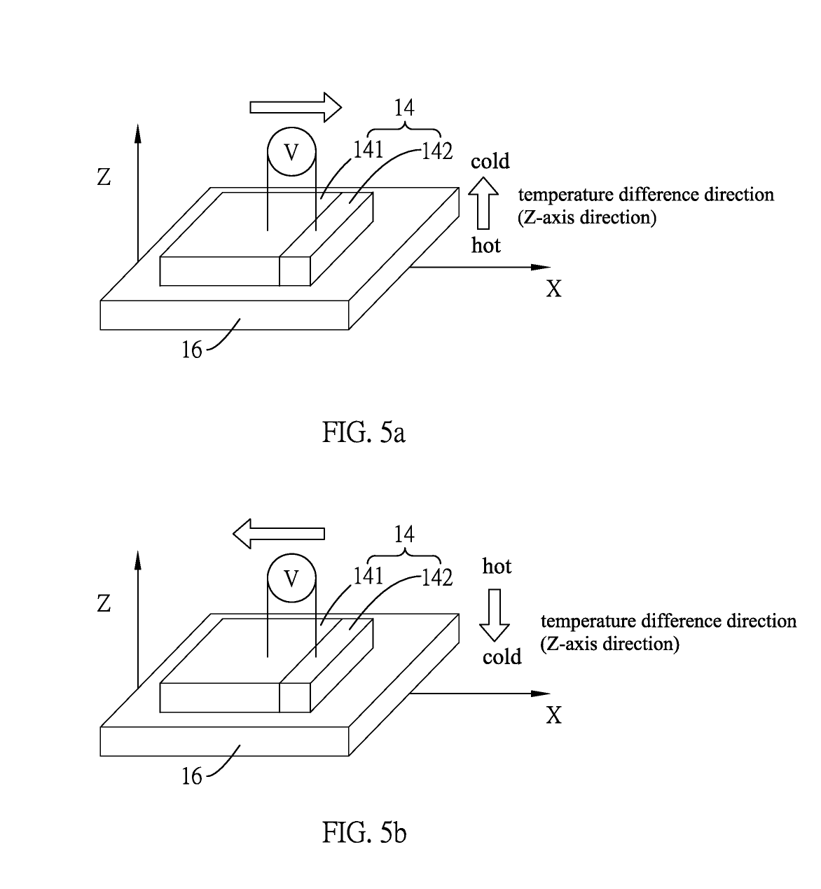

Please refer to FIG. 5a and FIG. 5b, which shows the second embodiment of the present invention. The one-side doped thermoelectric material 14 is placed on the thermoelectric module 16.

Supplying an input current to the thermoelectric module 16, results in the top surface of the T.E. module heating the one-side doped thermoelectric material 14. A temperature gradient is applied from the bottom to the top surface of the one-side doped thermoelectric material 14 (the temperature at the bottom surface which is in contact with the T.E. module is higher, and is lower than at the top surface), which is defined as a positive gradient (i.e. perpendicular to lay down the one-side doped thermoelectric material 14). Under these measurement settings, a positive voltage is sensed across the junction between the left (positive electrode) and right (negative electrode) ends of the doped thermoelectric material (i.e. the voltage direction is perpendicular to the temperature gradient of the one-side doped thermoelectric material 14).

In contrast, when reversing the direction of current input to the thermoelectric module (as shown in FIG. 5b), the cooling function is activated on the top of the module, which is in contact with the bottom surface of the one-side doped thermoelectric material 14. Thus the one-side doped thermoelectric material 14 is cooled down by the cooling process provided by the cooling component and the generated temperature gradient from the top to the bottom (the temperature at the top surface of the doped thermoelectric substrate is lower, and is higher at the bottom surface), and which is defined as a negative gradient. This negative gradient generates a negative voltage from the right (negative electrode) to left (positive electrode) end. The voltage direction is perpendicular to the temperature gradient of the doped

To sum up, the highly efficient thermoelectric material of the present invention combines the homogenous thermoelectric material 11 with one end coated in silver adhesive 12. After heating the homogeneous thermoelectric material 11 coated with silver adhesive 12 in a furnace, it becomes a one side doped thermoelectric material 14, which possesses a high thermoelectric figure of merit.

Many changes and modifications in the above-mentioned embodiment of the invention can, of course, be carried out without departing from the scope thereof. Accordingly, to promote progress in science and arts, the invention is disclosed and is intended to be limited only by the scope of the appended claims.

What is claimed is:

1. A highly efficient thermoelectric material, comprising:
a homogeneous thermoelectric material; and a silver adhesive, coated on one end of the homogeneous thermoelectric material; wherein, the homogeneous thermoelectric material coated with the silver adhesive is heated in a furnace for diffusion process so as to produce a one-side doped thermoelectric material.

2. The highly efficient thermoelectric material of claim 1, wherein the homogeneous thermoelectric material comprises a high carrier concentration region and a low carrier concentration region.

3. The highly efficient thermoelectric material of claim 1, wherein the silver adhesive is produced by a silver element.

4. The highly efficient thermoelectric material of claim 1, wherein the one-side doped thermoelectric material has a non-doped region and a doped region.

5. The highly efficient thermoelectric material of claim 4, wherein the doped region of the one-side doped thermoelectric material passes through the heater and a measuring device and is given a temperature difference, and test results obtained from the measuring device show a high thermoelectric figure of merit.

6. A highly efficient thermoelectric material, comprising:
a homogeneous thermoelectric material; and
a silver adhesive, coated on one end of the homogeneous thermoelectric material;
wherein, the homogeneous thermoelectric material coated with the silver adhesive is heated in a furnace for diffusion process so as to produce a one-side doped thermoelectric material, and the one-side doped thermoelectric material is placed on a thermoelectric module, and a current input to the thermoelectric module so that the thermoelectric module heats the one side doped thermoelectric material and produces a first temperature difference so as to obtain a positive voltage and its direction is perpendicular to the temperature gradient.

7. The highly efficient thermoelectric material of claim 6, wherein a reverse current is input to the thermoelectric module so that the module cools and lowers the temperature of the one side doped thermoelectric material and generates a second temperature difference, so as to obtain a negative voltage and its direction is also perpendicular to the temperature gradient.
